(19) United States
(12) Patent Application Publication
(10) Pub. No.: US 2018/0334293 A1
(43) Pub. Date: Nov. 22, 2018

(54) ENDCAP FOR A CROSSARM, RELATED SYSTEM, AND METHOD OF ASSEMBLY

(71) Applicant: MacLean Power, L.L.C., Fort Mill, SC (US)

(72) Inventor: Mitchell Henry Harrison Kadel, York, SC (US)

(73) Assignee: MacLean Power, L.L.C., Fort Mill, SC (US)

(21) Appl. No.: 15/599,853

(22) Filed: May 19, 2017

(51) Int. Cl. B65D 41/02; H02G 7/20; E04H 12/24; H02G 7/05; E04B 1/68

(52) U.S. Cl. CPC B65D 41/023; H02G 7/20; E04B 1/6803; H02G 7/05; E04H 12/24

(57) ABSTRACT

One general aspect of the present disclosure includes an endcap for a crossarm. The endcap may have a base portion with a surface configured to face a cavity of a crossarm, a hub extending from the surface and configured to receive a fastening element, a gusset element coupled to the hub, and a brace element. The brace element may be configured to contact an inner wall of the crossarm. The inner wall may at least partially define the cavity. The gusset element may be configured to provide an expansion force to the brace element when the fastening element is received by the hub.

### TECHNICAL FIELD

The present disclosure generally relates to endcaps for crossarms used in power transmission systems, systems including a crossarm and an endcap, and related methods of assembly.

### BACKGROUND

Power transmission systems often include above-ground utility poles for suspending electrical power lines. The utility poles are traditionally made from wood, steel, or concrete. When multiple power lines or other related components are supported, a utility pole may include a horizontal crossarm. Crossarms are typically formed of wood, steel, or polymer materials (e.g., plastic or fiberglass), and may be secured to the utility pole through a variety of hardware components. One or more ends of the horizontal crossarm may provide support for one or more suspended power lines. For example, the crossarm may be secured to a ceramic or polymer insulator that attaches directly to a suspended power line.

Crossarms are often formed of a hollow tube of a metal, polymer, or composite material. Unless the cavity of the hollow tube is closed and sealed, birds, insects, and other and other animals may inhabit the cavity, cause damage to certain components, safety issues and/or interfere with maintenance operations. A non-sealed hollow tube may also retain moisture, which may degrade the crossarm over time or promote electrical activity. To solve these issues, an endcap is typically secured to each end of the hollow tube. The endcap is typically secured to the crossarm by bonding to foam injected into the cavity. However, due to process variability, it is possible for the endcap to insufficiently bond with the foam, which may leave it susceptible to failure (by becoming easily dislodged from the crossarm, for example). This problem is typically solved by applying an adhesive to the endcap prior to assembly and/or screwing the crossarm to the endcap, but these solutions are associated with additional assembly time and may compromise the strength and durability of the crossarm and endcap.

### SUMMARY

One general aspect of the present disclosure includes an endcap for a crossarm. The endcap may have a base portion with a surface configured to face a cavity of a crossarm, a hub extending from the surface and configured to receive a fastening element, a gusset element coupled to the hub, and a brace element. The brace element may be configured to contact an inner wall of the crossarm. The inner wall may at least partially define the cavity. The gusset element may be configured to provide an expansion force to the brace element when the fastening element is received by the hub.

Another general aspect of the present disclosure includes a system having a crossarm, where the crossarm has a cavity defined by at least one inner wall, and an endcap. The endcap may include a base portion configured to at least partially seal an end of the cavity, a hub for receiving a fastening element, a gusset element coupled to the hub, and a brace element secured to the gusset element. The hub may be configured to expand when receiving the fastening element such that the brace element exerts a force on the at least one inner wall of the crossarm.

Another general aspect of the present disclosure is a method including the steps of placing an endcap at least partially within a cavity of a crossarm and receiving a fastening element with a hub of the endcap. The endcap may include a gusset element coupled to the hub and a brace element coupled to the gusset element. Receiving the fastening element may cause the gusset element to provide an expansion force to the brace element.

### BRIEF DESCRIPTION OF THE DRAWINGS

FIG. 1 is an exploded side-perspective view of a system with an endcap, a crossarm, and a fastening element in accordance with the present disclosure.

FIG. 2 is a bottom view of the endcap depicted in FIG. 1 secured to the crossarm of FIG. 1.

FIG. 3 is a side perspective view of the endcap of FIG. 1 secured to the crossarm of FIG. 1.

FIG. 4 is a side view of the endcap of FIG. 1 secured to the crossarm of FIG. 1.

### DETAILED DESCRIPTION

Various aspects are described below with reference to the drawings, and several of the elements are identified by numerals. The relationship and functioning of the various elements may better be understood by reference to the following description. However, aspects are not limited to those illustrated in the drawings or explicitly described below. The drawings are not necessarily to scale, and in certain instances, details may have been omitted that are not necessary for an understanding of aspects disclosed herein.

In this application, the use of the disjunctive is intended to include the conjunctive. The use of definite or indefinite articles is not intended to indicate cardinality. In particular, a reference to “the” object or “a or an” object is intended to denote also one of a possible plurality of such objects.

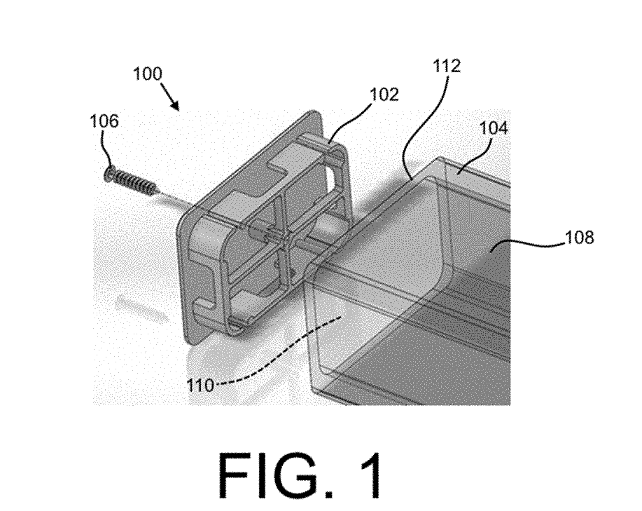

FIG. 1 is an exploded side-perspective view of a system 100 with an endcap 102, a crossarm 104, and a fastening element 106. In some non-limiting exemplary embodiments, the crossarm 104 may be a deadend or tangent utility crossarm sold by MacLean Power Systems™. The crossarm 104 may be formed substantially as a hollow tube 108 of a suitable material (e.g., a UV stabilized fiberglass). The hollow tube 108 may have any suitable cross sectional shape (e.g., circular, rectangular as shown), triangular, etc.). To prevent moisture and inhabitation of the cavity 110 of the tube 108 (e.g., by birds or insects), it may be advantageous to close the cavity 110 with the endcap 102 at least at one end 112 (and preferably both ends). As described in more detail below, the endcap 102 may be suitably secured to the crossarm 104 when the fastening element 106 is engaged with the endcap 102.

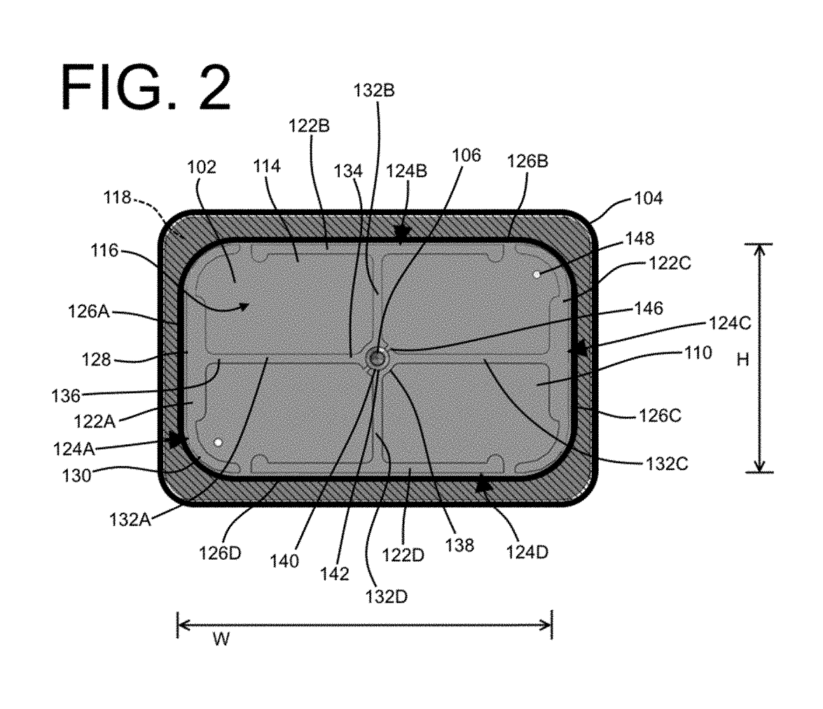

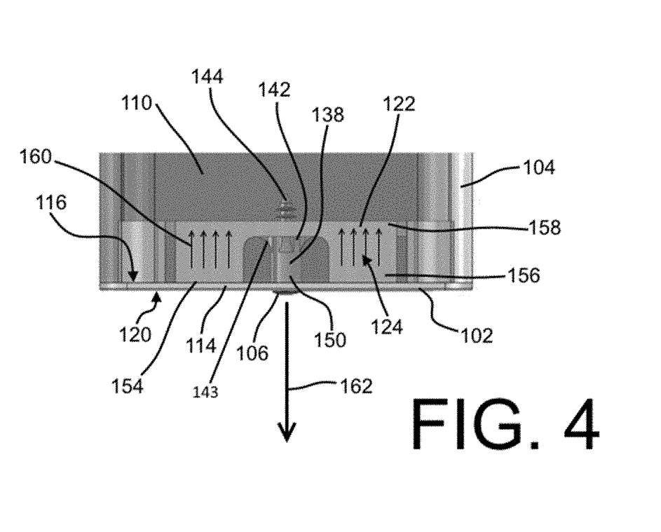

FIG. 2 is a bottom or end view of the endcap 102 depicted in FIG. 1 secured to the crossarm 104 of FIG. 2 (and the crossarm 104 is shown in bolded lines with translucent crosshatching). As shown in FIG. 2, the endcap 102 may include a base portion 114 with an inward-facing surface 116. When the endcap 102 is assembled to the crossarm 104, the inward-facing surface 116 may face the cavity 110 of the crossarm 104. The inward-facing surface 116 may be texturized, coated, finished, or otherwise configured to promote bonding with the crossarm 104 and/or with another object or substance (e.g., foam) within the cavity 110. When the endcap 102 is installed on the crossarm 104, an outer fringe 118 of the inward-facing surface 116 may abut a terminal end of the crossarm 104 (e.g., at the end 112 depicted in FIG. 1). The inward-facing surface 116 may be formed by a substantially flat, rectangular panel of a material, but any other suitable structure and/or shape may be used. An opposite outer-facing surface 120 (see FIG. 4) may face opposite the cavity 110, and may be configured for exposure to the outside environment. For example, the outer-facing surface 120 (FIG. 4) may be formed of a particular material or treated with a coating such that it is resistant to moisture, temperature changes, and other conditions that may be encountered. The remainder of the endcap 102 may optionally be formed of a different material, but the entirety of the endcap 102 may be formed of the same material, such as a fiberglass, metal, plastic, or another suitable material. It is contemplated that each of the components of the endcap 102 may be integrally formed (e.g., through injection molding).

Referring to FIG. 2, the endcap 102 may include a first brace element 122A with a first engagement surface 124A. The first engagement surface 124A may be sized, shaped, positioned on the first brace element 122A, and/or otherwise configured to contact a first inner wall 126A of the crossarm 104, where the first inner wall 126A at least partially defines the cavity 110 of the crossarm 104. As shown, the first engagement surface 124A may include a flat area 128 and a curved area 130. Including the curved area 130 may be advantageous for increasing the surface area of contact between the first engagement surface 124A and the first inner wall 126A and/or imparting the ability of the first engagement surface 124A to provide an expansion force in multiple directions (e.g., in a direction parallel to the width W and also in a direction parallel to the height H, for example). Similarly, a second brace element 122B, a third brace element 122C, and a fourth brace element 122D may be configured to contact a second inner wall 126B, a third inner wall 126C, and a fourth inner wall 126D of the crossarm 104, respectively. In other embodiments, more or fewer than four brace elements may be included with the endcap 102, particularly when the endcap 102 is designed for communication with a crossarm having a cross-sectional shape different than the cross-sectional shape of the depicted crossarm 104.

The first brace element 122A may be secured to a first gusset element 132A. The first gusset element 132A may have a first end 134 attached to a hub 138 and a second end 136 attached to the first brace element 122A. Optionally, the first gusset element 132A may be integrally formed with the hub 138, the first brace element 122A, or both. Similarly, second brace element 122B may be secured to (and integrally formed with) a second gusset element 132B, the third brace element 122C may be secured to a third gusset element 132C, and a fourth brace element 122D may be secured to the fourth gusset element 132D. In some embodiments, a brace element may be defined simply as an end of a gusset element.

An opening 140 may extend at least partially through the hub 138 and/or the base portion 114. In some embodiments (including the depicted embodiment), the opening 140 may extend through the entirety of the base portion 114 and the hub 138. The opening 140 may be configured (e.g., sized, shaped and positioned) to receive the fastening element 106. The fastening element 106 may be a screw, wedge, anchor, pin, hook, or other suitable device. When the fastening element 106 is threaded, the opening may include corresponding female threads. As shown in the depicted embodiment, the fastening element 106 may be inserted into the opening 140 with an outside-in orientation with respect to the cavity 110, but it is also contemplated that the fastening element 106 may be inserted from the inside with an inside-out orientation. The depicted outside-in orientation may be advantageous when it is desirable for the fastening element 106 to be accessible for potential removal of the endcap 102 at a later time, such as during maintenance operations.

The opening 140 may include a default state (e.g., a relaxed state when not engaged by the fastening element 106) and an expanded state. The diameter (or other cross-sectional dimension) of the opening 140 at the end 142 of the hub 138 may be larger when the opening is in the expanded state with respect to the default state. Thus, the opening 140 may move from the default state to the expanded state as it receives the fastening element 106. In some embodiments, the fastening element 106 may have a tapered end 144 (see FIG. 4) to facilitate expansion and initial receipt of the fastening element 106 within the opening 140 of the hub 138. Additionally or alternatively, the opening 140 of the hub 138 may include a tapered portion (e.g., the opening 140 may reduce its cross-sectional dimensions as it nears its inner end 142). Further, at least one slot 146 may be included to facilitate expansion of the opening 140, but the slot 146 may not be required if the hub 138 is formed of a material with a suitable elasticity. Even when a slot 146 is included, it may be advantageous for the first gusset element 132A and the second gusset element 132B to be connected at the inner end 142 of the hub 138 (as shown), which may retain proper respective orientation between the first gusset element 132A and the second gusset element 132B and/or reduce buckling risk. Similarly, the third gusset element 132C and the fourth gusset element 132D may be connected adjacent the inner end 142 of the opening 140, as shown.

As the opening 140 moves from its default state to the expanded state, it may provide an outward-facing or expansion force on the gusset elements 132A, 132B, 132C, and 132D. As a result, the gusset elements 132A, 132B, 132C, and 132D may provide a corresponding outward-facing or expansion force to the respective brace elements 122A, 122B, 122C, and 122D, which may provide a tendency for the brace elements 122A, 122B, 122C, and 122D to move/expand outwards. When the brace elements 122A, 122B, 122C, and 122D are placed within the cavity 110, the brace elements may move towards and engage their respective inner walls 126A, 126B, 126C, and 126D. Then, as the fastening element 106 continues to expand the opening 140, the gusset elements 132A, 132B, 132C, and 132D may begin to compress. The compression may in turn cause the engagement surfaces 124A, 124B, 124C, and 124D to exert a force (i.e., the expansion force) on their respective inner walls of the cavity 110, thereby increasing the maximum static friction between the engagement surfaces 124A, 124B, 124C, and 124D and the inner walls 126A, 126B, 126C, and 126D. As a result, the endcap 102 may become secured to the crossarm 104 in a substantially fixed manner.

When the endcap 102 is not engaged with the fastening element 106, the endcap 102 may be dimensioned such that the width W (defined in this embodiment by a distance between the first engagement surface 124A and the third engagement surface 124C) may be slightly smaller than a cross-sectional width of the cavity 110 of the crossarm 104. Similarly, the height H (defined in this embodiment by a distance between the second engagement surface 124B and the fourth engagement surface 124D) may be slightly smaller than a cross-sectional height of the cavity 110 of the crossarm 104. Advantageously, these dimensions may provide simple and efficient installation of the endcap 102 at the end of the crossarm 104, either prior to, during, or after installation of the crossarm 104 on a greater power system. It is also contemplated that at least one of width W and the height H of the endcap 102 may be slightly larger than respective cross-sections of the crossarm 104 prior to installation, particularly when the gusset elements 132A, 132B, 132C, and 132D are capable of being at least partially moved or compressed by hand. Such an embodiment may provide a small amount of friction between the engagement surfaces 124A, 124B, 124C, and 124D and the cavity 110 during the installation process (but prior to tightening a fastening element completely), which may be advantageous when it is desirable to retain the endcap 102 in place during installation at a worksite but to wait to finalize tightening until after adjustment of other components, for example. In one non-limiting embodiment, the width W may be about 5.4 inches and the height may be about 3.6 inches when the endcap 102 is in a default state, but any other suitable dimensions may be used, and the particular dimensions may be determined and selected based on the dimensions of the model of the crossarm 104.

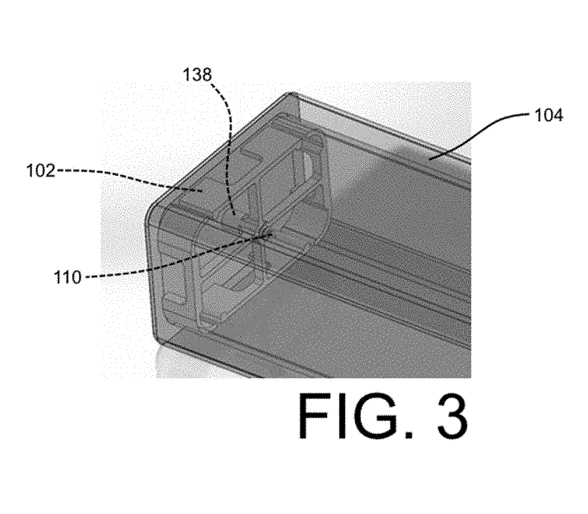

FIG. 3 is a side perspective view of the endcap 102 secured to the crossarm 104 by way of the fastening element 106 being received by the hub 138, as described above. The cavity 110, which may be sealed by the endcap 102, may optionally be filled with foam or another substance prior to, during, or after installation of the endcap 102 on the crossarm 104. The foam may be a low density polyurethane foam, for example. It is contemplated that the endcap 102 may include an opening for allowing foam to be injected into the cavity 110 after installation of the endcap 102 (such as at least one of the openings 148 shown in FIG. 2), but such an opening is optional. In yet another embodiment, an adhesive could optionally be applied around the outer fringe 118 prior to inserting the endcap 102 into the crossarm 104 and securing it with the fastening element 106.

FIG. 4 is a side view of the endcap 102 secured to the crossarm 104 in the manner described above. As shown in FIG. 4, the hub 138 includes a first end 150 secured to the base portion 114 and the inner or second end 142 (which may be expandable) secured to the brace element 122. The second end 142 may include a rib 143 for suitable connection to, support of, and force transfer to the corresponding gusset element. The brace element 122 may include an edge 154 that abuts or is directly adjacent to the base portion 114. In some embodiments, the edge 154 may secure a bottom portion 156 of the brace element 122 to the base portion 114 (e.g., such that only an upper portion 158 of the brace element 122 moves outwardly when the fastening element 106 is received). For example, the edge 154 of the brace element 122 may be formed integrally with the base portion 114 (and, while not show, it is contemplated that ribs similar to ribs 143 may reinforce the connection between the edge 154 and the base portion 114. In other embodiments, the edge 154 of the brace element 122 may be slidable with respect to, or spaced from, the inward-facing surface 116 of the base portion 114, which may be advantageous for preventing the inward-facing surface 116 from inhibiting the inward and outward motion of the brace element 122.

When the fastening element 106 is engaged with the endcap 102, static friction forces 160 between the endcap 102 and the inner walls of the crossarm 104 may counteract a force 162 pulling the endcap 102 along the longitudinal axis of the crossarm 104. In one test performed by the present inventors, a crossarm and endcap formed in accordance with the present disclosure (without foam in the cavity 110) successfully resisted a force 162 of 35 pounds prior to the endcap moving with respect to the crossarm. With the addition of foam, the design exceeded the load capacity of the testing device (which was 50 pounds). These results represent a substantial improvement with respect to available endcaps at the time of filing of this application, which typically can be removed from a crossarm by applying a 5 pound force or less.

Specific embodiments have been described for the purpose of illustrating the manner in which the aspects of the present disclosure are used. It should be understood that the implementation of other variations and modifications of the embodiments described herein and their various aspects will be apparent to one skilled in the art, and that the invention is not limited by the specific embodiments described.

We claim:

1. An endcap for a crossarm, the endcap comprising:
a base portion with a surface configured to face a cavity of a crossarm;
a hub extending from the surface and configured to receive a fastening element;
a gusset element coupled to the hub; and
a brace element,
wherein the brace element is configured to contact an inner wall of the crossarm, the inner wall at least partially defining the cavity, and
wherein the gusset element is configured to provide an expansion force to the brace element when the fastening element is received by the hub.

2. The endcap of claim 1, wherein the hub includes an opening, and wherein the opening of the hub is configured to receive the fastening element.

3. The endcap of claim 2, wherein the opening includes a tapered end.

4. The endcap of claim 1, wherein the hub is configured to expand in response to receiving the fastening element, and wherein the expansion of the hub moves or compresses the gusset element.

5. The endcap of claim 1, further comprising:
a second brace element configured to contact a second inner wall of the crossarm, the second inner wall of the crossarm at least partially defining the cavity of the crossarm.

6. The endcap of claim 5, further comprising:
a second gusset element coupled to the hub and configured to provide an expansion force to the second brace element when the fastening element is received by the hub.

7. The endcap of claim 6, further comprising:
a third brace element configured to contact a third inner wall of the crossarm; and
a fourth brace element configured to contact a fourth inner wall of the crossarm.

8. The endcap of claim 7, wherein the gusset element is attached to the second gusset element at an inner end of the hub, and wherein the third gusset element is attached to the fourth gusset element at an inner end of the hub.

9. The endcap of claim 7, wherein where a slot is located between the second gusset element and the third gusset element.

10. The endcap of claim 1, wherein the base portion includes an outer fringe configured to abut a terminal end of the crossarm.

11. The endcap of claim 1, wherein the brace element includes an engagement surface for contacting the inner wall of the crossarm, and wherein the engagement surfaces includes a flat area and a curved area.

12. A system, the system comprising:
a crossarm, the crossarm having a cavity defined by at least one inner wall; and
an endcap, the endcap including:
a base portion configured to at least partially seal an end of the cavity;
a hub for receiving a fastening element;
a gusset element coupled to the hub; and
a brace element secured to the gusset element,
wherein the hub is configured to expand when receiving the fastening element such that the brace element exerts a force on the at least one inner wall of the crossarm.

13. The system of claim 12, wherein the hub includes an opening, and wherein the opening of the hub is configured to receive the fastening element.

14. The system of claim 13, wherein the fastening element and the opening have corresponding threads.

15. The system of claim 12, wherein the fastening element includes a tapered end.

16. The system of claim 12, wherein the gusset element compresses when the hub receives the fastening element and when the brace element is engaged with the at least one inner wall of the crossarm.

17. The system of claim 12, wherein the brace element is engaged with the at least one inner wall of the crossarm, and wherein a foam is located within the cavity.

18. A method, the method comprising:
placing an endcap at least partially within a cavity of a crossarm; and
receiving a fastening element with a hub of the endcap, wherein the endcap includes a gusset element coupled to the hub and a brace element coupled to the gusset element, and wherein receiving the fastening element causes the gusset element to provide an expansion force to the brace element.

19. The method of claim 18, further comprising engaging an inner wall of the crossarm with the brace element, wherein the inner wall at least partially defines the cavity.

20. The method of claim 18, further comprising placing foam in the cavity.
